(19) United States
(12) Patent Application Publication
(10) Pub. No.: US 2011/0083350 A1
(43) Pub. Date: Apr. 14, 2011

(54) WARNING APPROACH SIGN

(76) Inventors: Larry Eugene WILLIAMS, Levelland, TX (US); Nickey Joe WILLIAMS, Levelland, TX (US); Benny Ray SHERROD, Midland, TX (US)

(21) Appl. No.: 12/576,935

(22) Filed: Oct. 9, 2009

(51) Int. Cl. G09F 15/00; G01P 13/00; G01W 1/00

(52) U.S. Cl. 40/606.03

(57) ABSTRACT

A warning sign for use at a site where the risk of hazardous materials is present such as hydrocarbon wells and processing equipment wherein the sign provide satisfying indicia and indicates wind direction and intensity allowing for a soft approach to the site from an upwind position.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### SUMMARY

A warning sign for use around hazardous sites such as hydrocarbon wells and production and processing equipment. In general, the sign includes a frame having a print receiving surface of sufficient size to display location, materials, and site identifying information. The frame is mounted to pivot about a vertical axis whereby, the size and shape of the sign and the location of the pivot axis are arranged to permit, the sign to pivot with wind currents to indicate wind direction to allow an approach to the equipment in a downwind direction from an upwind location. The pivot is designed so that the sign can be supported on a variety of shaped support posts. The sign also includes a wind speed indicator, which provides information regarding the relative danger from gas leaks at the equipment from hazardous materials.

These and other features and advantages of the present inventions will be more readily appreciated when considered in conjunction with the accompanying drawings in which an embodiment of the apparatus is illustrated.

### BRIEF DESCRIPTION OF THE DRAWING

The accompanying drawings are incorporated into and form a part of the specification to illustrate examples according to the current most-preferred embodiments of the present inventions. The drawings are only for illustrating a preferred and alternative example of the inventions and are not to be construed as limiting the inventions to only the illustrated and described example. The drawings include the following figures:

FIG. 1 is a front elevation of the warning sign according to the present inventions;

FIG. 2 is a top plan view warning sign illustrated in FIG. 1 according to the inventions;

FIG. 3 is a sectional view of the warning sign taken along lines 3-3 of FIG. 1 looking in the direction of the arrows according to the inventions;

FIG. 4 is a sectional view of the warning sign taken along line 4-4 of FIG. 3 looking in the direction of the arrows according to the inventions;

FIG. 5 is an exploded cross section view of the pivot mounting for the warning sign according to the inventions;

FIG. 6 is an exploded cross section view of an alternative pivot mounting for the warning sign according to the inventions; and

FIG. 7 is an enlarged partial section view of the pivot mounting for the warning sign according to the inventions.

### DETAILED DESCRIPTION OF THE INVENTION

Leaks or discharges of toxic gasses at hazardous sites such as oil wells, processing equipment, pipeline pumping equipment, gas storage tanks, and the like present a potentially dangerous situation for personnel working in the area. For example, toxic natural gas can be colorless and odorless. Estimating wind direction and speed is inexact in determining danger levels and approaches.

Government regulations regarding hydrocarbon well heads require signs be present at the site identifying the particular well. In fields where numerous closely spaced wells are present, identifying a particular well requires approaching the sign to determine the identity of the well. These signs are fixed in place and require an approach facing the sign to read the identifying information. In some wind conditions the approach to the sign can be in a dangerous up wind direction.

As used herein, corrugated material includes corrugated paperboard or “cardboard” and at least two outer sheets called liners joined together by corrugated shaped sheets called fluting. For example, double wall corrugated material has three separate liners separated by two fluting sheets. The fluting sheet forms a plurality of elongated voids between the liners that extend across the corrugated material. Fluting direction, as used herein, refers to the direction parallel the extension of the voids formed by the fluting sheet.

As used herein, each of the words “comprise,” “has,” and “include” as well as all grammatical variations thereof are intended to have an open, non-limiting meaning that do not exclude additional elements or steps. It should also be understood that, as used herein, “first,” “one,” “second,’ and “third” are arbitrarily assigned to structure or items and are merely intended to differentiate, as the case may be, and do not indicate any sequence. Furthermore, it is to be understood that the mere use of the term “first’ or “one” does not require that there be any “second,” and the mere use of the word “second” does not require that there be any “third,” etc. Up and down are used in reference to the top and bottom of the referenced drawing and may or may not necessarily refer to the actual directions.

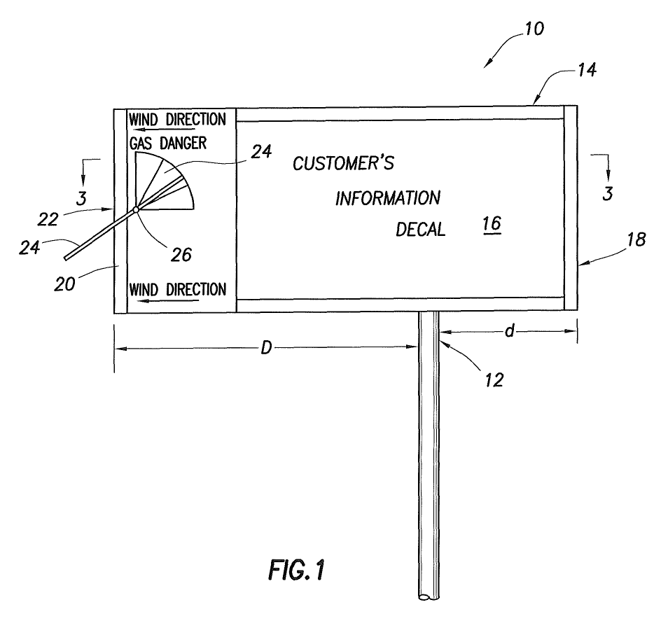

Referring now to the drawings, wherein reference numbers are used to designate like or corresponding parts, there is illustrated in FIG. 1 an embodiment of the warning sign assembly 10 of the present invention. The sign assembly comprises a support post 12 and a pivot assembly (not shown in FIG. 1) supporting a rotating sign board assembly 14 from the post 12.

In the illustrated embodiment, the post 12 is vertically extending and has a cylindrical external surface, however, as discussed herein, the pivot assembly (not shown in FIG. 1) can be used with non-circular cross section posts, such as T-posts, quadrilateral shaped tubing, channels, angles, and the like. The post 12 can be embedded in the ground, welded, or otherwise supported from the associated equipment such that at least a portion of the post is vertically extending.

The sign board assembly 14 is illustrated as having two opposed rectangular shaped panel surfaces 16, however, it is envisioned that other surface shapes would be functional. The panel surfaces 16 are illustrated as being planar and of a size for receiving indicia providing identifying marking and warning information. In the illustrated embodiment, the rectangular shaped panel surfaces 16 are about 14 inches high and 32 inches wide.

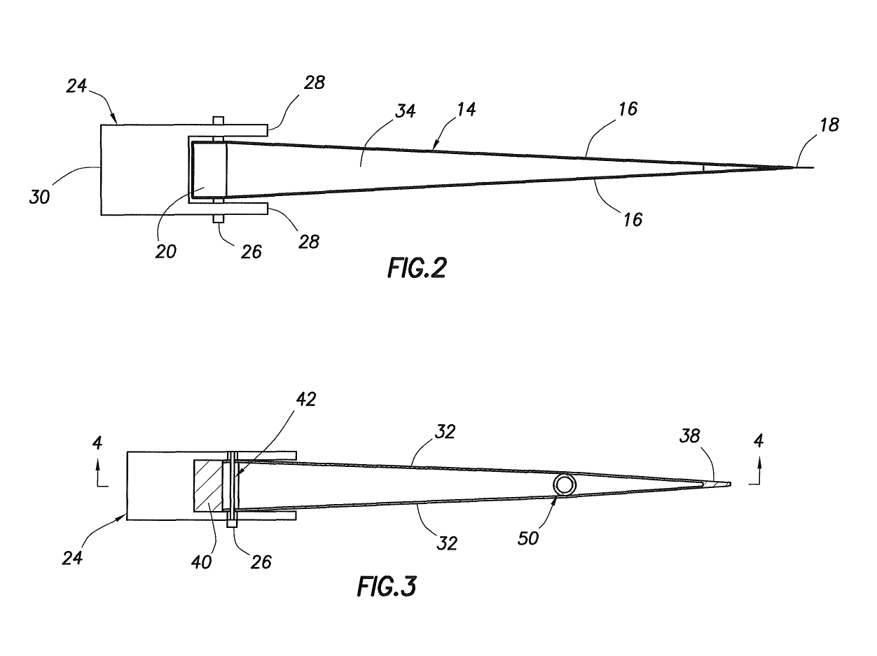

As can be seen in the top plan view, FIG. 2, the sign board assembly 14 has a wedge shaped cross section with a converging or front end 18 and a diverging or rear end 20. The wedge shape enhances or improves the ability of the sign board 14 to orient itself with respect to the wind. However, it is envisioned that a uniform or non-tapered cross section could be used.

In the illustrated embodiment the pivot assembly and its vertical post 12 are eccentrically located closer to the converging end 18 than the diverging end 20 of the sign board 14. In FIG. 1, the sign board dimension “d” is illustrated as being less than the dimension “D”. In the illustrated embodiment the dimension “d’ is proportioned to be about one half of the dimension “D”. This eccentric location of the pivot also enhances or improves the ability of the sign board 14 to orient itself with respect to the wind.

A wind speed warning indicator assembly 22 is mounted on the sign board 14. The indicator 22 comprises a wind plate 24 pivotally mounted on a pivot shaft 26. Pivot shaft 26 is supported from the sign board 14 adjacent to the diverging end 20. The pivot axis, created by the shaft 26, generally extends horizontally. As shown in FIG. 2, the wind plate 24 has wind engaging surfaces and is bifurcated to form flanges 28 making the wind plate generally “U” shaped. The wind plate flanges 28 are positioned on opposite sides of the diverging end 20. As shown, the bifurcated portion is attached to the shaft 26 to allow the wind plate to pivot horizontally. The wind plate is designed to be off balance. The outer plate edge 30 is heavy with respect to the pivot, so that gravitational forces will cause the outer wind plate edge 30 to assume the declining position, shown in FIG. 1, with the edge 46 of the wind plate 24 resting against the outer surface of diverging end 20 to limit downward rotation of the edge 30. When wind currents act on the sign, the sign will rotate about the pivot so that the converging end 18 faces upwind. Also the wind plate 24 will rotate clockwise (as shown in FIG. 1) about axis 26 proportioned to wind velocity The wind plate 24 is off balance so that it will be lifted (moved toward horizontal) in proportion to wind velocity. Indicia 48 can be provided on the sign board 14 calibrated to wind speed and danger levels of gas exposure. While an off balance wind plate configuration has less moving parts, a resiliently urged wind plate can be used.

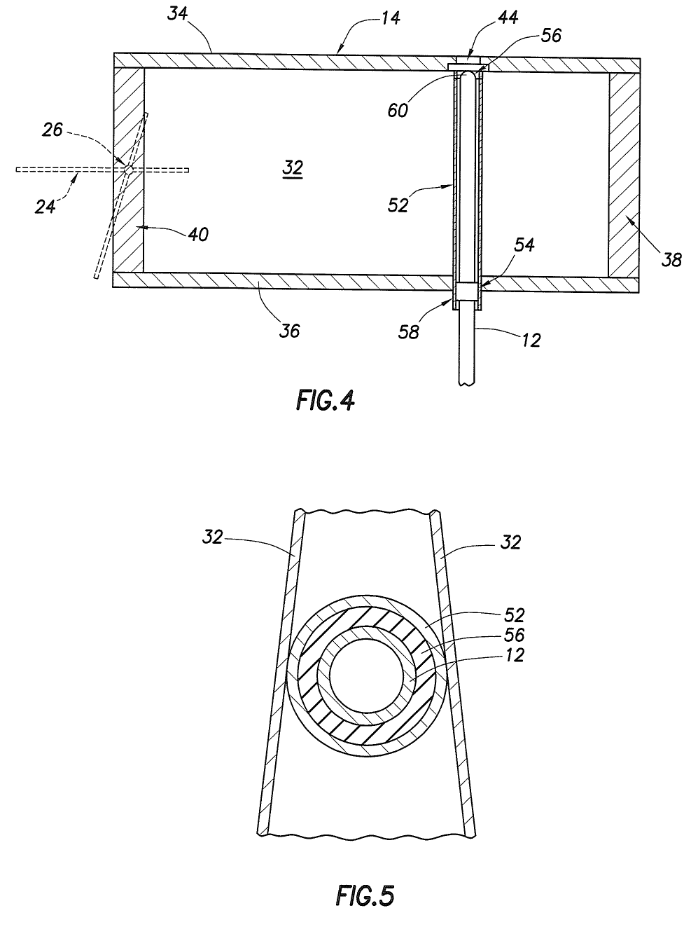

Interior details of the sign assembly 10 are illustrated in FIGS. 3-4. The sign board 14 is comprised of two sign panels 32 (forming the panel surfaces 16); upper, lower, converging front end, and diverging rear end caps 34, 36, 38, and 40, respectively. The upper and lower caps are triangular shaped and support the panels 32. The converging end cap 38 abuts the ends of the panels 32 and closes off the seam formed between them at the tapered end. The caps are joined together and form a frame to which the panels 32 are joined. The method of assembly shown is by bonding, however, any suitable manner could be used to form the rigid sign board. The diverging end cap 40 closes off the diverging end 20 and includes a tubular support 42 through which the shaft 26 extends and is supported. A recess can be formed in the upper cap 34 for receiving a compass 44.

Details of the sign board pivot assembly 50 are illustrated in FIGS. 4 and 5. A cylindrical sleeve 52 is mounted to extend between the upper and lower caps 34 and 36, respectively. In the embodiment of FIG. 4, a circular opening 54 is formed through the lower cap and sleeve 52 extends through the opening and a short distance below it. Upper and lower bushings 56 and 58, respectively, are located in the sleeve 52. These bushings are dimensioned to fit snugly in the sleeve 52 and have an internal diameter to receive the post 12 therein, for rotational movement. Alternatively, the sleeve 52 is of a size and shape to fit and rotate in the sleeve without the pressure of bushings 56 and 58. A curved (in the illustrated embodiment semi-circular) shaped pivot assembly cap 60 is connected to the upper end of the post 12. This pivot assembly cap 60 rests on the underside of upper cap 34 to support the sign board assembly 14. As shown in FIG. 7 a threaded set screw 62 can be installed in the sleeve 52 to engage a anular groove 63 in the post 12 to hold the sign assembly in place axially while allowing it to rotate.

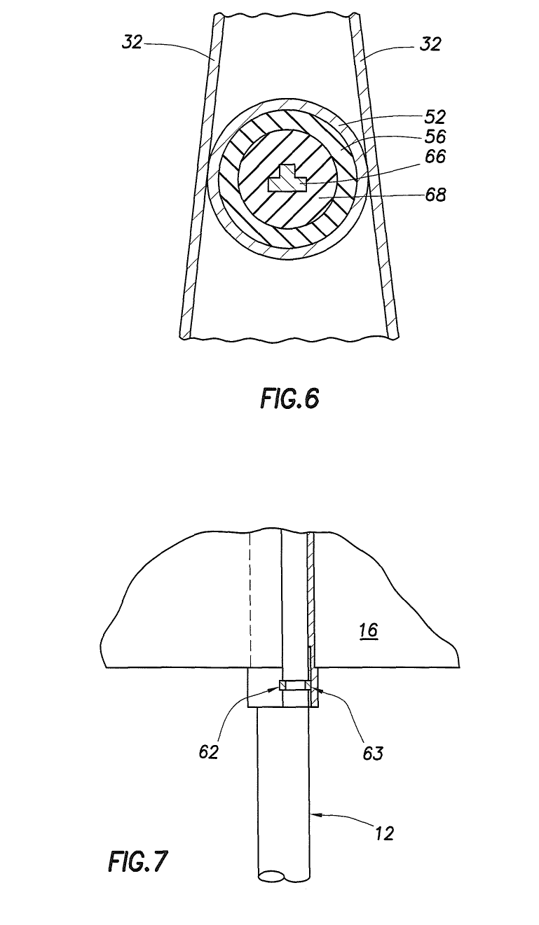

An alternative embodiment of a sign board pivot assembly is illustrated in FIG. 6. In this embodiment, the post 66 is non-circular and is illustrated by example as being a “t” shaped drive post 66. A cylindrical sleeve 68 is provided with an interior opening of a size and shape to fit over the “t” post 66. The sleeve 68 is sized to fit in the bushings 56 and 58 to allow the sign board 14 to rotate. The sleeve has a cap (not shown) formed or installed on its upper end that is similar to the pivot assembly cap 60. Alternatively, the sleeve 68 is of a size to fit and rotate in the sleeve 52 without the presence of bushing 56 and 58.

When the sign has been installed at a hazardous site, such as a hydrocarbon well head, the sign will rotate to a position indicating the wind direction and speed. Personnel can approach the site from a direction facing the sign board panels 32. This direction is cross wind from the well and is relatively safe under most wind conditions. When close enough to read the indicia 48 on the panel, the individual can verify the identity of the site and whether hazardous materials are present. An approach from a downwind direction from an upwind location can then be made to the site to avoid hazardous leaks on the downwind side.

It is to be understood that numerous modifications, alterations, and changes can be made in the inventions without departing from the spirit and scope of the inventions as set forth in the appended claims. It is the intention to cover all embodiments and forms of the inventions within the allowable scope of the claims.

What is claimed is:

1. An information and warning marker for a site with dangerous gaseous material, comprising:
a post for mounting in a stationary position at the site, the post having a portion that is vertically extending when the post is mounted in a stationary position;
a sign having a front end, a rear end and two substantially opposed panel surfaces, the panel surfaces being suitable for receiving visible indicia whereby legible information can be placed on the panel surfaces;
a mounting pivotally connecting the sign to the vertically extending portion of the post with the two panel surfaces each extending substantially vertically, the mounting being connected to the sign to permit the sign to pivot about a vertically extending axis to align with the front end of the sign upwind of its rear end to indicate wind direction by the sign's position; and
a wind speed indicator having a wind engaging surface, an indicator pivot pivotally connecting the indicator to the sign adjacent the rear end of the sign, the indicator pivot being connected to the sign to permit the indicator to pivot about a horizontally extending axis in response to wind speed and thereby indicate wind speed by the indicator's position.

2. The apparatus according to claim 1, wherein the two panel surfaces are diverging with respect to each other.

3. The apparatus according to claim 1, wherein the sign board pivot comprises a sleeve of a size and shape to receive the vertically extending portion of the post and to permit the sign to pivot about the vertically extending portion.

4. The apparatus according to claim 1, wherein the sign has a wedge shape cross section with the side panels converging adjacent the front end and diverging at the rear end thereby creating a profile that tends to cause the sign to rotate about the sign pivot with the front end of the sign located up wind and the rear end of the si

5. The apparatus according to claim 1, wherein the sigh comprises front, rear, upper and lower caps, side panels attached to the caps, and a sleeve with a cylindrical interior mounted to extend between the upper and lower caps, a circular opening extends through the lower cap aligned with the sleeve interior where by the vertically extending post portion can be received in the sleeve allowing the sign to pivot about the post portion.

6. The apparatus according to claim 1, wherein the wind speed warning indicator is mounted on the sign and comprises:
a wind plate having a wind engaging surface thereon, the wind plate having a bifurcated portion forming a pair of flanges;
the wind plate is mounted on the sign with the two flanges positioned on opposite sides of the diverging end of the sign; and
a pivot shaft attached to the two flanges extending transversely through the sign panels for rotation of the wind plate about a horizontally extending axis in response to changes in wind speed.

7. The apparatus according to claim 1, wherein the sign is connected to the post at a vertical axis located closer to the front end than the rear end.

8. The apparatus according to claim 1, wherein the vertically extending portion of the post engaging the sign has a cylindrical outer surface.

9. The apparatus according to claim 1, wherein the vertically extending portion of the post engaging the sign has a non cylindrical outer surface and additionally comprising a sleeve with an interior opening of a size and shape to fit over the post and an external cylindrical surface.

10. The apparatus according to claim 3, wherein the vertically extending portion of the post engaging the sign has a non cylindrical outer surface and additionally comprising a sleeve with an interior opening of a size and shape to fit over the post and an external cylindrical surface of a size and shape to pivot in the sleeve.

11. The apparatus according to claim 3 additionally comprising at least one busing mounted inside the sleeve of a size and shape to receive the vertically extending portion of the post therein for pivotal movement.
